(19) United States
(12) Patent Application Publication
(10) Pub. No.: US 2013/0266385 A1
(43) Pub. Date: Oct. 10, 2013

(54) Cutting Insert, a Tool Holder, and Tool for Forming Heavy Duty Threads

(71) Applicant: VARGUS LTD., Nahariya (IL)

(72) Inventors: Rafael Margulis, Carmiel (IL); Artur Zaretsky, Nesher (IL)

(73) Assignee: Vargus Ltd., Nahariya, IL (US)

(21) Appl. No.: 13/859,238

(22) Filed: Apr. 9, 2013

(30) Foreign Application Priority Data
Apr. 10, 2012 (EP) 12163610.4

(51) Int. Cl. B23B 27/16; B23B 29/04

(52) U.S. Cl. CPC B23B 27/16; B23B 29/043
USPC 407/102; 407/120; 407/66

(57) ABSTRACT

The invention relates to a cutting insert (3), a tool holder (2), and tool (1) for forming heavy duty threads, wherein the tool holder (2) has a support surface (20) and the cutting insert (3) is releaseably securable to the support surface (20) of the tool holder (2), such that a longitudinal direction (I) of the cutting insert (3) in use extends in parallel to radial direction of a workpiece, the cutting insert (2) is provided with at least one cutting edge (30) and a bottom surface (31) for contacting the support surface of the tool holder, the bottom surface (31) being stepped to provide a first planar contact portion (31a) and a second planar contact portion (31b) adjacent thereto, and a first abutment wall (33) extending at least partially in the longitudinal direction (I) being formed between the first planar contact portion (31a) and the second planar contact portion (31b).

### CROSS REFERENCE TO RELATED APPLICATIONS

This application claims priority to EP 12163610.4, filed Apr. 10, 2012, the entire contents of which is hereby incorporated by reference.

### FIELD OF APPLICATION AND PRIOR ART

The invention relates to a cutting insert, a tool holder, and a tool for forming heavy duty threads.

In the context of the application, thread forms having a stronger thread profile than standard threads, such as ISO metric screw threads or UTS threads, are referred to as heavy duty threads. The stronger thread profiles make the heavy duty threads particularly useful in translational applications such as power transmission applications involving moving heavy machine loads as found on machine tools, slurry pumps etc. Typically, with heavy duty threads pitches range from 10 mm to 24 mm. A large number of heavy duty threads are formed as “trapezoidal” threads or trapeze threads, i.e. threads with included angles between 29° and 30°. Examples for heavy duty threads include (not limited to) Knuckle Threads (DIN 20400), Acme, Stub Acme, ISO TR-DIN 103, Buttress, and Dardelet threads.

For forming a heavy duty thread it is well known to use a turning lathe, in short lathe, in particular a numerically controlled lathe, wherein a tool comprising a tool holder and a cutting insert affixed thereto is fed to a workpiece or machined component.

U.S. Pat. No. 7,832,964 B2 relates to an indexable turning insert, comprising an upperside and an underside between which three side surfaces extend that are situated in a first imaginary, equilateral triangle and therefore converge in pairs at an angle of 60° toward corners in which cutting edges are included, wherein the underside includes three elongate and straight engagement members, each defined by a groove having a pair of opposite diverging flanks, and located in a second imaginary triangle having an equilateral shape, which is smaller than the first imaginary triangle and rotated in relation to the first imaginary triangle.

US 2007/0245866 A1 proposes an insert for forming a heavy duty thread, which insert is received in a pocket of a tool holder having converging sidewalls, wherein at least one insert supporting surface comprises a pattern of recessed and projecting areas corresponding to and being adapted to locate the insert relative to a pattern of projecting and recessed areas on a corresponding abutment surface of the pocket of the tool holder. The projecting and recessed areas extend in parallel with a longitudinal centreline of the insert and, in use of the insert, parallel to the radial direction of the workpiece.

It is the object of the invention to provide a cutting insert and a tool for forming heavy duty threads by turning with a high rigidity of the tool for producing heavy duty threads of high quality and in short cycle times.

This object is solved by a cutting insert, a tool holder, and a tool comprising a cutting insert and a tool holder with the features of claims 1, 9, and 13.

It is the basic idea of the invention to provide a cutting insert for forming a heavy duty thread, which insert is releaseably securable to a tool holder having a support surface, such that a longitudinal direction of the cutting insert in use extends in parallel to a radial direction of a workpiece, wherein the cutting insert is provided with a top surface having at least one cutting edge and a bottom surface for contacting the support surface of the tool holder, the bottom surface being stepped to provide a first planar contact portion and a second planar contact portion adjacent thereto, and a first abutment wall extending at least partially in the longitudinal direction being formed between the first planar contact portion and the second planar contact portion.

The at least one cutting edge is provided on at least one cutting tip or cutting corner of the insert. The direction, in which the cutting tip protrudes, is defined as the longitudinal direction of the insert. The longitudinal direction in one embodiment coincides with the radial direction of the workpiece within machining tolerances.

In use, cutting forces act on the cutting edge. The first abutment wall prevents or at least hampers a rotational displacement of the cutting insert due to the cutting forces. In particular when forming a thread with a flank infeed or a modified flank infeed, the first abutment wall extending in the longitudinal direction is suitable for counteracting the cutting forces.

In the context of the application, a radial feed direction is defined as the radial direction of the workpiece, in which the tool is fed towards the workpiece. An axial feed direction is defined as the direction parallel to the longitudinal direction, also referred to as axis of rotation, of the workpiece, in which the tool is fed. During machining, the tool is moved along the longitudinal direction of workpiece with a constant radial feed depth. For each subsequent pass, the infeed depth is increased and the cutting process is repeated. The ratio between the increase in radial feed depth and the increase in axial feed depth for subsequent passes determines the infeed angle. In the context of the application, the infeed angle is defined as the angle between the longitudinal axis of the workpiece and the (main) cutting edge or cutting tip. An infeed with an infeed angle of 0° is referred to as radial infeed. When using a radial infeed, the tool is fed in the radial feed direction for subsequent passes. Thereby, a chip is removed from both sides of thread flanks formed and, depending on the shape of the cutting edge, a U-shaped or V-shaped chip is formed. Due to this form of the chip, in some applications a chip flow may cause problems. In particular when forming a heavy duty thread with pitches ranging for example from 14 mm to 24 mm, an infeed with an infeed angle greater than 0°, more particular greater than 15°, preferably between 15° and 30° is advantageous. In the context of this application, an infeed with an infeed angle between 10° and 35°, preferably between 15° and 30°, wherein the infeed angle is parallel with the flank of the thread to be formed, is referred to as flank infeed. An infeed with an infeed angle between 10° and 35°, preferably between 15° and 30°, wherein the infeed angle is offset to the flank of the thread to be formed by an offset angle, is referred to as modified flank infeed. The offset angle preferably is chosen between 0.5° and 3°. All pitch and angle specifications are given by way of example only and include respective tolerance ranges.

According to one embodiment, the first abutment wall extends perpendicular to the first and the second contact portion. A respective first abutment wall can be formed with high precision.

According to another embodiment, the first abutment wall is oriented away from a cutting entry side of the insert. The cutting entry side is defined in the context of the application as the side of the insert facing in the feed direction. When using a flank infeed, the main cutting edge is provided at the cutting entry side. A cutting force when turning with a flank infeed or a modified flank infeed will be transferred from a body of the cutting inserts directly to the holder via the first abutment wall.

According to another embodiment, the first abutment wall extends over the length of insert in the longitudinal direction. This allows a simple manufacturing avoiding the formation of insular contact portions confined by a plurality of potential abutment walls.

In another embodiment, a second abutment wall extending at an angle to the longitudinal direction, in particular extending perpendicular to the longitudinal direction, is provided at a side surface of the insert between the bottom surface and a top surface. The second abutment wall is preferably provided at a side surface opposite a cutting tip or cutting corner at which the at least one cutting edge is provided. The second planar contact portion is offset to the first planar contact portion in a direction away from a top surface. Preferably, an inclined transition wall is provided at least between the second abutment wall and the second planar contact portion of the insert for avoiding an interlocking in corner region between the second abutment wall and the second planar contact portion when positioning the insert on the tool holder.

In one embodiment, the cutting insert is fixed to the tool holder by means of a clamping jaw. In preferred embodiments, a through-hole is provided for receiving a clamping screw for fixing the cutting insert to the tool holder. In one embodiment, an additional clamping jaw is provided. In one embodiment, the through-hole is provided in the shadow of the cutting edge. In the context of the application, a region spanned by the cutting edge of the cutting insert is referred to as shadow of the cutting edge. By locating the clamping inside the cutting edge of the insert, a clamping of the insert to the tool holder is further improved.

According to a second aspect, a tool holder for a tool for forming a heavy duty thread is provided, the tool holder having a support surface that is stepped to provide a first planar support portion and a second planar support portion adjacent thereto with a first counter abutment wall between the first planar support portion and the second planar support portion for receiving a cutting insert.

In one embodiment, the first counter abutment wall is non-linear and at least partly curved or buckled, wherein at least a section of the first counter abutment wall extends in the radial feed direction of the tool holder. In use, the radial feed direction of the tool holder coincides with the longitudinal direction of the insert secured to the tool holder. The section of the first counter abutment wall is explicitly suitable to receive a component of a load applied to the insert by a cutting force in the axial feed direction. In order to avoid an over-determination when positioning the insert, the section is chosen small enough for minimizing the contact area, but large enough for ensuring a force transmission. The wide of the first planar support portion of the tool holder in the axial feed direction in preferred embodiments is chosen sufficiently large for providing a sufficient volume and, hence, a sufficient strength of the first planar support portion in the region of the section even when the length in the radial feed direction of the tool holder is minimized.

In one embodiment, the tool holder comprises a shank and a projection, wherein the support surface is provided on the projection. The shape of the projection and/or the support surface is matched to the shape of the insert.

In another embodiment, a second counter abutment wall extending at an angle to the radial feed direction, in particular extending perpendicular to the radial feed direction is provided. The second counter abutment wall is provided to balance a component of the cutting force in contact with the second abutment wall. In preferred embodiments the second counter abutment wall is divided in at least two sections offset to each other for realizing a stable positioning at the two sections.

According to a third aspect, a tool for forming a heavy duty thread comprising a tool holder and a cutting insert is provided. In preferred embodiments, the tool further comprises a clamping screw. The tool has a high rigidity and allows to machine heavy duty threads with high accuracy.

Preferred embodiments are defined in the dependent claims.

In the following, an embodiment of the invention will be described in detail based on several schematic drawings in which

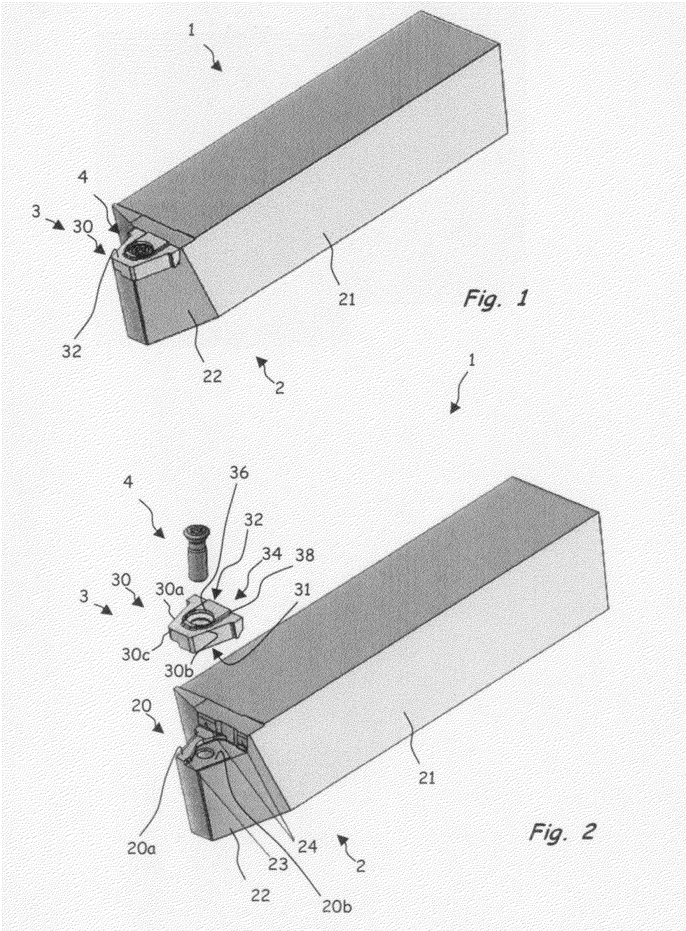

FIG. 1 is an isometric view of tool comprising a tool holder with a cutting insert;

FIG. 2 is an exploded isometric view of the tool of FIG. 1;

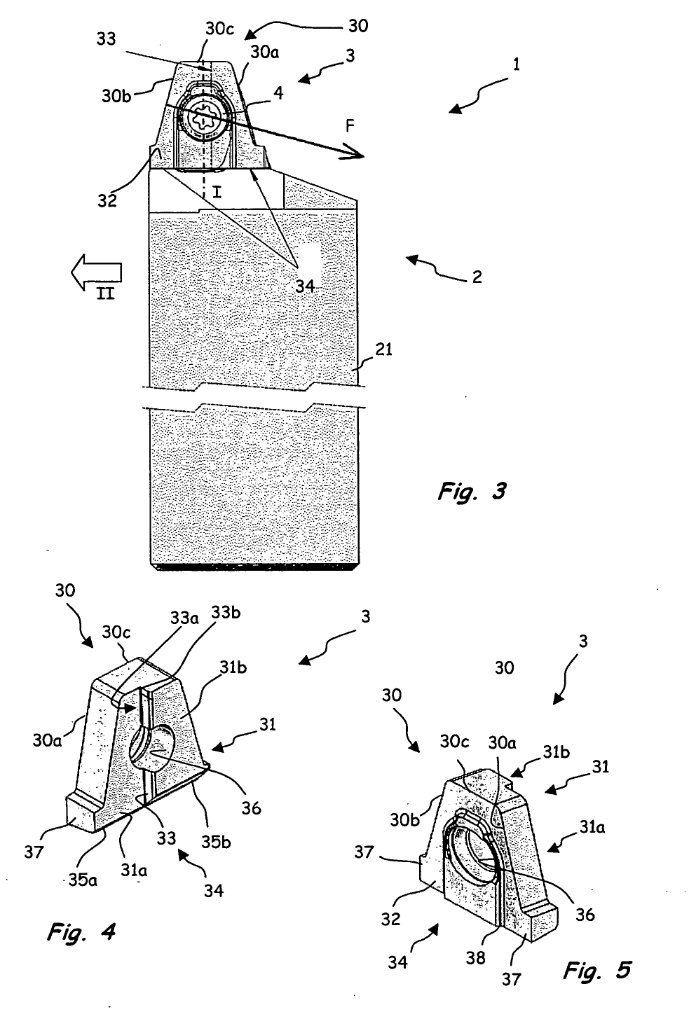

FIG. 3 is a top view of the tool of FIG. 1;

FIG. 4 is an isometric view from the bottom on the cutting insert of FIG. 1; and

FIG. 5 is an isometric view from the top on the cutting insert of FIG. 1

Throughout the drawings, the same elements will be denoted by the same reference numerals.

FIGS. 1, 2 and 3 show a tool 1 comprising a tool holder 2, a cutting insert 3 (also referred to simply as insert 3) and a clamping screw 4 in an isometric view, an exploded isometric view, and a top view, respectively. FIGS. 4 and 5 show isometric views from the bottom and the top on the insert 3 of FIG. 1, respectively.

The cutting insert 3 is releasably secured to the tool holder 2, more particular to a support surface 20 (see FIG. 2) of the tool holder 2, such that a longitudinal direction I of the cutting insert 3 in use extends parallel to a radial direction of a workpiece (not shown).

The tool holder 2 comprises a shank 21 and a projection 22 formed integrally with the shank 21, wherein the support surface 20 is provided on the projection 22. In the depicted embodiment, the form of the projection 22 of the tool holder 2 coincides with the form of the insert 3. In other embodiments, the insert 3 partly protrudes from the support surface 20.

The cutting insert 3 is provided with a cutting edge 30, a bottom surface 31 for contacting the support surface 20 of the tool holder 2, and a top surface 32, wherein the cutting edge 30 is provided at an edge of the top surface 32. The bottom surface 31 is stepped to provide a first planar contact portion 31a and a second planar contact portion 31b adjacent thereto. By providing the step, the second planar contact portion 31b is offset to the first planar contact portion 31a in a direction away from the top surface 32 of the insert 3. The top surface 32 is essentially planar, therefore the height of the insert 3 perpendicular to the bottom surface 31 differs in the areas of the first planar contact portion 31a and the second planar contact portion 31b. Between the first planar contact portion 31a and the second planar contact portion 31b a first abutment wall 33 extending in the longitudinal direction I over the entire length of insert 3 is formed. In the embodiment shown, transition regions 33a, 33b are formed between the first abutment wall 33 and the first contact portion 31a and the second contact portion 31b, respectively, for avoiding overdeterminations when securing the insert 3 to the tool holder 2.

A second abutment wall 34 extending perpendicular to the longitudinal direction I is provided at a side surface of the insert between the bottom surface 31 and a top surface 32. Inclined transition walls 35a, 35b are provided between the second abutment wall 34 and the first planar contact portion 31a and the second planar contact portion 31b, respectively, for avoiding an interlocking in corner regions when positioning the insert 3 on the support surface 20. In the depicted embodiment, the inclined transition walls 35a, 35b are formed with a common inclination angle, thereby the size of the inclined transition wall 35b between the second abutment wall 34 and the second planar contact portion 31b exceeds the size of the inclined transition wall 35a provided between the second abutment wall 34 and the first planar contact portion 31a.

The support surface 20 of the tool holder 2 is also stepped to provide a first planar support portion 20a and a second planar support portion 20b adjacent thereto with a first counter abutment wall 23 between the first planar support portion 20a and the second planar support portion 20b for receiving the cutting insert 3. The first counter abutment wall 23 is nonlinear and comprises a curved section and a planar section, wherein the planar section is provided at the distal end of the projection 22 and extends in the radial feed direction. When positioning the insert 3 on the tool holder 2, the abutment wall 33 contacts the planar section of the counter abutment wall 23.

The tool holder 2 is further provided with a second counter abutment wall 24, which delimits the support surface 20 at the back in the radial feed direction. In the depicted embodiment the counter abutment wall 24 is divided in two sections offset to each other in the axial feed direction. Thereby, two distinct abutment areas are provided.

The cutting edge 30 is formed with a profile for forming a desired thread profile. The cutting edge 30 shown in the figures is essentially U-shaped with three part edges, namely a first flank edge 30a, a second flank edge 30b, and a central or outer part edge 30c, sandwiched between the first flank edge 30a and the second flank edge 30b.

The shape of the insert 3 is chosen to match the profile of the thread formed. In the depicted embodiment, the cutting insert 3 has an essentially trapezoidal shape, with two bases of different length, wherein the second abutment surface 34 is provided on the longer base of the trapezoid and the central edge 30c of the cutting edge 30 is provided on the opposite base of the trapezoid. The first flank edge 30a and the second flank edge 30b are provided on the flanks of the trapezoid.

The cutting insert 3 is provided with a through-hole 36 and the tool holder 2 is provided with a complementary thread hole for receiving the clamping screw 4. The through-hole 36 for the clamping screw 4 is located inside a region spanned by the cutting edge 30 of the cutting insert 3. This region is also referred to as shadow of the cutting edge 30.

On each side surface of the cutting insert 3, at which the first flank edge 30a and the second flank edge 30b, respectively, are located, a side wing 37 is provided. The side wings 37 define the depth of the thread to be cut. In preferred embodiments, the side wings 37 are provided with a secondary cutting edge for a deburring of the crest of the cut thread. The top surface 32 is provided with a step 38 in the region of the through-hole 36 for the clamping screw 4. The step 38 allows for an improved formation of the cutting edge 30 and, if applicable the secondary cutting edge formed at the side wings 37.

The tool 1 is moved in a feed direction II shown in FIG. 3 for forming a thread in a workpiece. When using a flank infeed or a modified flank infeed, the second flank edge 30b provided at a cutting entry side of the insert 3, i.e. at the side of the insert 3 facing in the feed direction II, functions as main cutting edge. A cutting force F acting on the insert 3 when using a flank infeed or a modified flank infeed is schematically shown in FIG. 3. In the embodiment shown, the first abutment wall 33 is oriented away from the cutting entry side. The cutting force F is transferred from the cutting inserts 3 via the first abutment wall 33 and the second abutment wall 34 to the counter abutment surfaces 23 and 24 of the tool holder 2, respectively. This allows a very stable positioning with high rigidity. As in the depicted embodiment, the clamping screw 4 is located in the shadow of the cutting edge 30, a clamping of the insert 3 to the support surface 20 and the counter abutment surfaces 23 and 24 is further enhanced.

1. A cutting insert for forming a heavy duty thread, wherein the insert is releaseably securable to a tool holder having a support surface, such that a longitudinal direction of the cutting insert in use extends in parallel to a radial direction of a workpiece, the cutting insert comprising:
a top surface having at least one cutting edge; and
a bottom surface for contacting the support surface of the tool holder,
wherein the bottom surface is stepped to provide a first planar contact portion and a second planar contact portion adjacent thereto,
wherein a first abutment wall extending at least partially in the longitudinal direction is formed between the first planar contact portion and the second planar contact portion.

2. The cutting insert according to claim 1, wherein the first abutment wall extends perpendicular to the first and the second contact portion.

3. The cutting insert according to claim 1, wherein the first abutment wall is oriented away from a cutting entry side of the insert.

4. The cutting insert according to claim 1, wherein the first abutment wall extends over the length of insert in the longitudinal direction.

5. The cutting insert according to claim 1, wherein a second abutment wall extending at an angle to the longitudinal direction, in particular extending perpendicular to the longitudinal direction, is provided at a side surface of the insert between the bottom surface and a top surface.

6. The cutting insert according to claim 5, wherein an inclined transition wall is provided at least between the second abutment wall and the second planar contact portion, wherein the second planar contact portion is offset to the first planar contact portion in a direction away from the top surface of the insert.

7. The cutting insert according to claim 1, wherein a through-hole is provided for receiving a clamping screw.

8. The cutting insert according to claim 7, wherein the through-hole is provided in a shadow of the cutting edge.

9. A tool holder for a tool for forming a heavy duty thread, the tool holder having a support surface,
wherein the support surface is stepped to provide a first planar support portion and a second planar support portion adjacent thereto with a first counter abutment wall between the first planar support portion and the second planar support portion for receiving a cutting insert in accordance with claim 1.

10. The tool holder according to claim 9, wherein the first counter abutment wall is non-linear and at least partly curved or buckled, wherein at least a section of the first counter abutment wall extends in a radial feed direction of the tool holder.

11. The tool holder according to claim 9, wherein the tool holder comprises a shank and a projection, wherein the support surface is provided on the projection.

12. The tool holder according to claim 9, wherein a second counter abutment wall extending at an angle to radial feed direction, in particular extending in an axial feed direction, is provided.

13. A tool for forming a heavy duty thread, comprising a tool holder and a cutting insert according to claim 1.

14. The tool for forming a heavy duty thread according to claim 13, further comprising a clamping screw.
